(19) United States
(12) Patent Application Publication
(10) Pub. No.: US 2015/0007241 A1
(43) Pub. Date: Jan. 1, 2015

(54) VIDEO DISTRIBUTION SERVER AND VIDEO DISTRIBUTION METHOD

(71) Applicant: Kabushiki Kaisha Toshiba, Tokyo (JP)

(72) Inventor: Mayumi Narukawa, Tokyo (JP)

(21) Appl. No.: 14/486,830

(22) Filed: Sep. 15, 2014

Related U.S. Application Data
(63) Continuation of application No. PCT/JP2013/051479, filed on Jan. 24, 2013.

(30) Foreign Application Priority Data
Mar. 15, 2012 (JP) 2012-058483

(51) Int. Cl. H04N 21/231; H04N 21/239; H04N 21/218

(52) U.S. Cl. CPC H04N 21/23106; H04N 21/2182; H04N 21/2393; H04N 21/23113
USPC 725/115

(57) ABSTRACT

According to one embodiment, a video distribution server includes an SSD, a counter, a determination unit, an output unit, and a first and second distribution controller. The first distribution controller, when target content data of a request belongs to a preferential data, reads the target content data from the SSD. The first distribution controller buffers the read target content data in a first storage area included in the output unit, and distributes the buffered target content data to a request source. The first distribution controller caches the read target content data in a second storage area included in the output unit. When the first distribution controller receives a request for the target content data after the caching of the target content data, the first distribution controller distributes the cached target content data to a request source.

### CROSS-REFERENCE TO RELATED APPLICATIONS

This application is based upon and claims the benefit of priority from prior Japanese Patent Application No. 2012-058483, filed Mar. 15, 2012, the entire contents of which are incorporated herein by reference.

### FIELD

Embodiments described herein relate generally to a video distribution server for saving data in a Solid State Drive (SSD), and a video distribution method to be used in this video distribution server.

### BACKGROUND

A video distribution server has a function of distributing content data saved in an internal storage to a large number of users at the same time. To simultaneously distribute content data to a number of users, the video distribution server is required to rapidly read content data. Therefore, the video distribution server includes a plurality of SSDs in the storage, and reads content data in parallel from the plurality of SSDs by using a RAID method. Note that the SSD requires neither a time for moving a read device on a disk nor a time necessary for an area recording desired data to rotate to the read device, and hence is capable of read and write faster than a Hard Disk Drive (HDD). Also, to simultaneously distribute content data to a number of users, the video distribution server performs network processing for distribution by hardware-based protocol processing by using a Field Programmable Gate Array (FPGA).

The video distribution server has the problem that when a read request is issued immediately after a content data write process is requested for an SSD, a delay occurs in the read process.

### BRIEF DESCRIPTION OF THE DRAWINGS

FIG. 1 is a block diagram showing the functional configuration of a network system to which a video distribution server according to the first embodiment is connected.

FIG. 2 is a block diagram showing the functional arrangement of the video distribution server shown in FIG. 1.

FIG. 3 is a block diagram showing the functional arrangement of a main controller shown in FIG. 2.

FIG. 4 is a flowchart showing an operation when the main controller shown in FIG. 2 distributes content data to a communication terminal.

FIG. 5 is a schematic view showing a case in which content data having content ID: No. 05 is stored in a second storage area shown in FIG. 2.

FIG. 6 is a view showing an example of the correspondence between content IDs and counter values.

FIG. 7 is a block diagram showing the functional arrangement of a main controller of a data distribution server according to the second embodiment.

FIG. 8 is a flowchart showing an operation to be performed by the main controller shown in FIG. 7 in response to a distribution request.

FIG. 9 is a view showing an example of a change in number of distribution requests with time with respect to predetermined content data.

FIG. 10 is a flowchart showing an operation by which the main controller shown in FIG. 7 switches storage areas which output partial content data.

FIG. 11 is a flowchart showing an operation by which the main controller shown in FIG. 7 caches partial content data in a second storage area.

FIG. 12 is a view showing examples of the partial content data to be cached in the second storage area by the main controller shown in FIG. 7.

### DETAILED DESCRIPTION

In general, according to one embodiment, a video distribution server includes an SSD, a counter, a determination unit, an output unit, and a first and second distribution controller. A plurality of content data are written in the SSD. The counter, when distribution of one of the plurality of content data written in the SSD is requested, increments a counter value of the content data for which distribution is requested. The determination unit determines whether the requested content data belongs to preferential data having ordinal numbers preset in descending order of counter value, by comparing counter values of the individual content data. The output unit includes a first storage area which buffers content data read from the SSD and a second storage area which caches content data read from the SSD. The output unit distributes one of content data buffered in the first storage area and content data cached in the second storage area. The first distribution controller receives a first distribution request. The first distribution controller, when first target content data as a target of the first distribution request belongs to the preferential data, reads the first target content data from the SSD. The first distribution controller buffers the read first target content data in the first storage area. The first distribution controller caches the read first target content data in the second storage area. The first distribution controller distributes the buffered first target content data to a request source of the first distribution request. The second distribution controller receives a second distribution request. The second distribution controller, when second target content data as a target of the second distribution request does not belong to the preferential data, reads the second target content data from the SSD in accordance with the second distribution request. The second distribution controller buffers the read second target content data in the first storage area. The second distribution controller distributes the second target content data to a request source of the second distribution request. When the first distribution controller receives a third distribution request for the first target content data after the first target content data is cached in the second storage area, the first distribution controller distributes the cached first target content data in the second storage area to a request source of the third distribution request.

Embodiments will be explained below with reference to the accompanying drawings.

### First Embodiment

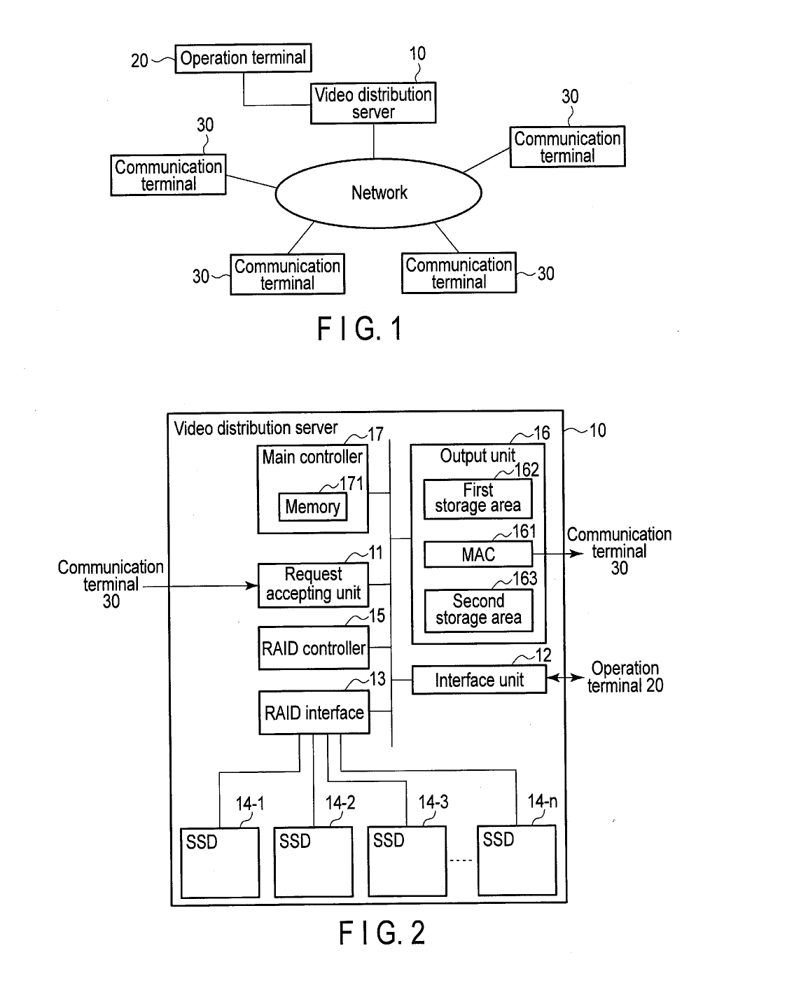

FIG. 1 is a block diagram showing the functional configuration of a network system to which a video distribution server 10 according to the first embodiment is connected. The network system includes the video distribution server 10, an operation terminal 20, and a plurality of communication terminals 30 such as a PC, smartphone, cell phone, Set-Top Box (STB), and IPTV. The video distribution server 10 is connected to the operation terminal 20 via, e.g., a LAN cable. The video distribution server 10 is also connected to the communication terminals 30 across the network.

In accordance with a distribution request supplied from the communication terminal 30, the video distribution server 10 distributes a content recorded in it to the communication terminal 30 by, e.g., a pre-downloading method or streaming method. Note that content distribution is performed using various distribution protocols such as an HTTP distribution protocol.

In accordance with a write request supplied from the operation terminal 20, the video distribution server 10 records a new content supplied from the operation terminal 20. Also, in accordance with a write request supplied from the operation terminal 20, the video distribution server 10 replaces the already recorded content with the new content supplied from the operation terminal 20.

FIG. 2 is a block diagram showing the functional arrangement of the video distribution server 10 according to the first embodiment. The video distribution server 10 shown in FIG. 2 includes a request accepting unit 11, an interface unit 12, a RAID interface 13, Solid State Drives (SSDs) 14-1 to 14-n, a RAID controller 15, an output unit 16, and a main controller 17. The request accepting unit 11, interface unit 12, RAID interface 13, RAID controller 15, output unit 16, and main controller 17 are connected by a bus.

The request accepting unit 11 accepts a distribution request transmitted across the network from the communication terminal 30. The request accepting unit 11 outputs the accepted distribution request to the main controller 17.

The interface unit 12 receives a write request supplied from the operation terminal 20, and content data supplied from the operation terminal 20. The interface unit 12 outputs the received write request to the main controller 17, and the content data to the RAID controller 15.

The RAID interface 13 is an interface between the bus and SSDs 14-1 to 14-n. Signals transmitted through the bus are supplied to the SSDs 14-1 to 14-n via the RAID interface 13. Signals output from the SSDs 14-1 to 14-n are supplied to the bus via the RAID interface 13.

The RAID controller 15 performs data write using the RAID method on the SSDs 14-1 to 14-n in accordance with a write request supplied from the main controller 17. That is, in accordance with a write request supplied from the main controller 17, the RAID controller 15 divides content data supplied from the interface unit 12 into predetermined volumes, and forms redundancy data for restoring the divided data. The RAID controller 15 stores the divided data and redundancy data in the SSDs 14-1 to 14-n.

Also, the RAID controller 15 performs data read using the RAID method on the SSDs 14-1 to 14-n in accordance with a read request supplied from the main controller 17. That is, in accordance with a read request supplied from the main controller 17, the RAID controller 15 reads the divided data and redundancy data recorded in the SSDs 14-1 to 14-n. The RAID controller 15 restores abnormal data or missing data from the read divided data and redundancy data. The RAID controller 15 forms the original content data from the read divided data and the restored data. The RAID controller 15 outputs the formed content data to the output unit 16.

When a read request to which management information (to be described later) is added is supplied from the main controller 17, the RAID controller 15 outputs content data within a range designated by the management information to the output unit 16.

Each of the SSDs 14-1 to 14-n includes a storage medium. In accordance with write control from the RAID controller 15, the SSDs 14-1 to 14-n write the divided data and redundancy data supplied from the RAID controller 15 in the storage media in parallel. The divided data and redundancy data recorded in the SSDs 14-1 to 14-n have a striping structure. Also, in accordance with read control from the RAID controller 15, the SSDs 14-1 to 14-n read the divided data and redundancy data written in the storage media in parallel. Note that this embodiment will be explained by taking a case in which a plurality of content data are recorded in the SSDs 14-1 to 14-n as an example.

The output unit 16 includes a Media Access Controller (MAC) 161, first storage area 162, and second storage area 163.

The first storage area 162 is formed by, e.g., an SDRAM. In accordance with a buffer instruction given by the main controller 17, the first storage area 162 holds content data supplied from the RAID controller 15 in a ring buffer for each session established in accordance with a distribution request. The buffer instruction in this embodiment is an instruction which causes the first storage area 162 to hold content data. The first storage area 162 outputs the held content data to the MAC 161 in accordance with processing of the MAC 161.

The second storage area 163 is formed by, e.g., an SDRAM. In accordance with a cache instruction given by the main controller 17, content data supplied from the RAID controller 15 is cached in the second storage area 163. The second storage area 163 outputs the cached content data to the MAC 161 in accordance with an output instruction given by the main controller 17.

The MAC 161 is formed by, e.g., a Field Programmable Gate Array (FPGA). In accordance with a session establishment request supplied from the main controller 17, the MAC 161 establishes a session with the communication terminal 30 having transmitted a distribution request. The MAC 161 converts content data supplied from the first or second storage area into a form complying with the communication protocol of the established session. The MAC 161 outputs the converted signal to the network.

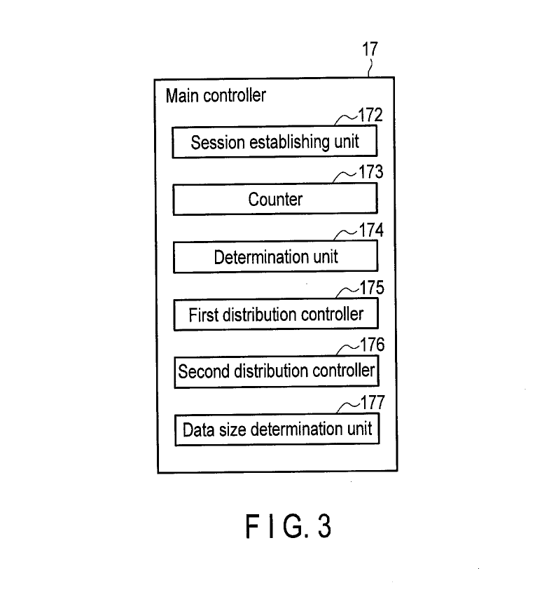

The main controller 17 includes, e.g., a Central Processing Unit (CPU), and achieves functions shown in FIG. 3 by driving the CPU by using programs and data recorded in a memory 171. That is, the main controller 17 includes a session establishing unit 172, counter 173, determination unit 174, first distribution controller 175, second distribution controller 176, and data size determination unit 177.

When a distribution request is supplied from the request accepting unit 11, the session establishing unit 172 outputs a session establishment request to the output unit 16.

When a distribution request is supplied from the request accepting unit 11, the counter 173 confirms the content ID of content data as a target of the distribution request. The counter 173 increments a counter value corresponding to the requested content ID. The counter 173 causes the memory 171 to store the counter value corresponding to the content ID.

When the counter value is incremented, the determination unit 174 compares counter values corresponding to all content IDs recorded in the memory 171, and determines whether the requested content data is preferential data. The preferential data herein mentioned are content data having ordinal numbers preset in descending order of counter value, i.e., content data having counter values from the highest value to the Nth value.

If the determination unit 174 determines that the requested content data is preferential data, the first distribution controller 175 performs a process of distributing the requested content data. That is, if the determination unit 174 determines that the requested content data is preferential data, the first distribution controller 175 determines whether the requested content data is already stored in the second storage area 163.

If the requested content data is not stored in the second storage area 163, the first distribution controller 175 outputs a read request to the RAID controller 15 so as to output the content data. Based on a notification from the data size determination unit 177, the first distribution controller 175 determines whether the volume of the content data exceeds the capacity of the second area 163. If the former exceeds the latter, the first distribution controller 175 outputs a cache instruction to the output unit 16 so as to cache a part of the content data output from the RAID controller 15 in the second storage area 163. The first distribution controller 175 outputs a buffer instruction to the output unit 16 so as to hold the rest of the content data output from the RAID controller 15 in a ring buffer. Also, if the volume of the content data does not exceed the capacity of the second area 163, the first distribution controller 175 outputs a cache instruction to the output unit 16 so as to cache the content data output from the RAID controller 15 in the second storage area 163. The first distribution controller 175 outputs a buffer instruction to the output unit 16 so as to hold the content data output from the RAID controller 15 in the ring buffer of the first storage area 162.

If the requested content data is already stored in the second storage area 163, the first distribution controller 175 refers to management information recorded in the memory 171, and determines whether the cached content data is a part of the content data recorded in the SSDs 14-1 to 14-n. If the cached content data is a part of the content data recorded in the SSDs 14-1 to 14-n, the first distribution controller 175 outputs an output instruction to the output unit 16 so as to output the content data cached in the second storage area 163. The first distribution controller 175 outputs a read request to which management information is added to the RAID controller 15 so as to output a portion not cached in the second storage area 163. The first distribution controller 175 outputs a buffer instruction to the output unit 16 so as to hold the rest of the content data output from the RAID controller 15 in the ring buffer.

If the whole of the content data recorded in the SSDs 14-1 to 14-n is cached in the second storage area 163, the first distribution controller 175 outputs an output instruction to the output unit 16 so as to output the content data cached in the second storage area 163.

If the determination unit 174 determines that the requested content data is not preferential data, the second distribution controller 176 performs a process of distributing the requested content data. That is, if the determination unit 174 determines that the requested content data is not preferential data, the second distribution controller 176 outputs a read request to the RAID controller 15 so as to output the content data. The second distribution controller 176 outputs a buffer instruction to the output unit 16 so as to hold the content data output from the RAID controller 15 in the ring buffer.

When caching the content data read from the SSDs 14-1 to 14-n in the second storage area 163, the data size determination unit 177 determines whether the volume of the requested content data is smaller than an area allocated to cache one content data in the second storage area 163. If the data volume is smaller than the allocated area, the data size determination unit 177 notifies the first distribution controller 175 of this information. If the data volume is larger than the allocated area, the data size determination unit 177 notifies the first distribution controller 175 of this information. When receiving the notification indicating that the data volume is smaller than the allocated area, the first distribution controller 175 causes the second storage area 163 to cache the content data recorded in the SSDs 14-1 to 14-n. When receiving the notification indicating that the data volume is larger than the allocated area, the first distribution controller 175 causes the allocated area to cache content data within a range cacheable in the allocated area, and records management information with which the range stored in the allocated area can be grasped in the memory 171.

Next, the operation of the data distribution server 10 configured as described above will be explained in detail.

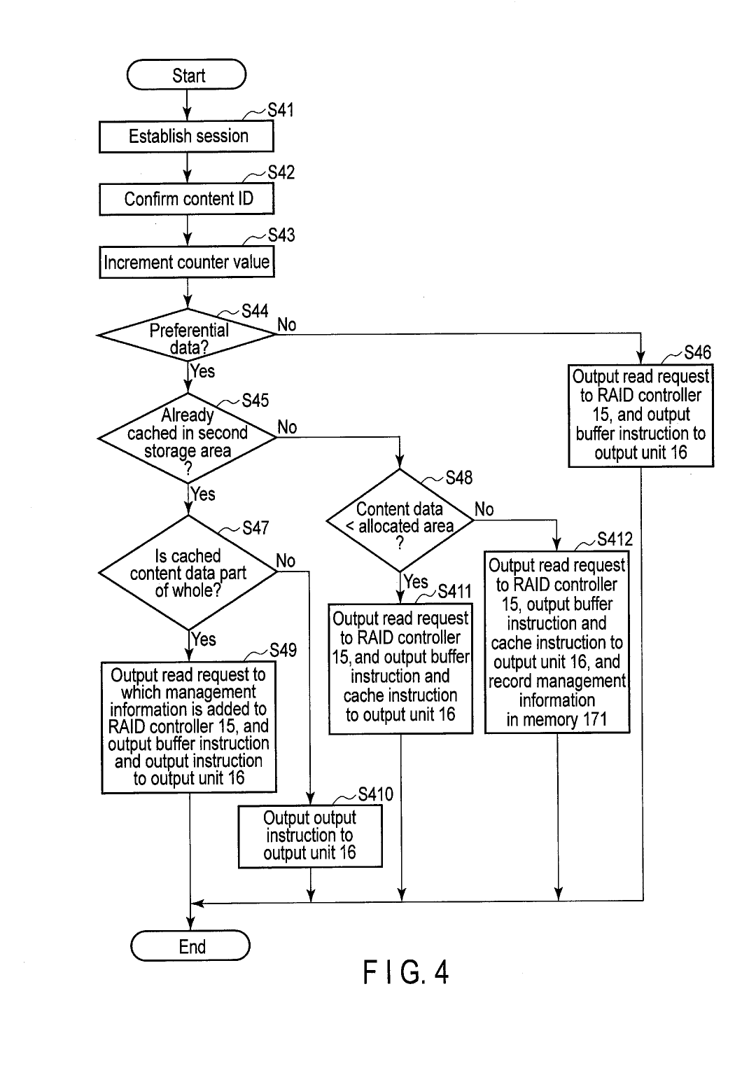

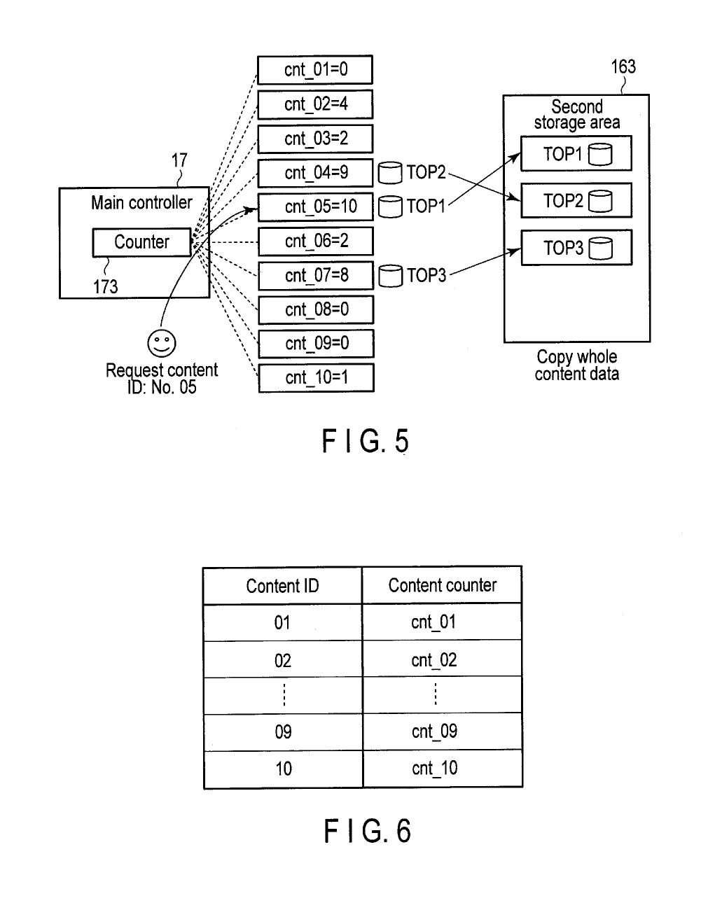

FIG. 4 is a flowchart showing an operation when the main controller 17 according to this embodiment distributes content data to the communication terminal 30. In FIG. 4, the operation will be explained by taking a case in which it is determined that top three content data from one having the highest counter value are preferential data as an example. FIG. 5 is a schematic view showing a case in which when the user of the communication terminal 30 requests content data having content ID: No. 05, the content data having content ID: No. 05 is stored in the second storage area 163. Note that FIG. 6 is a view showing an example of the correspondence between the content IDs and counter values.

First, when a distribution request is supplied from the request accepting unit 11, the main controller 17 causes the session establishing unit 172 to output a session establishment request to the output unit 16 (step S41). In accordance with this session establishment request from the main controller 17, the MAC 161 of the output unit 16 establishes a session with the communication terminal 30 having transmitted the distribution request.

The counter 173 confirms the content ID of content data as a target of the distribution request (step S42). The counter 173 increments a counter value corresponding to the requested content ID (step S43). Since the requested content ID is No. 05 in FIG. 5, the counter value of content ID: No. 05 is incremented.

The determination unit 174 determines whether the requested content data is preferential data by comparing counter values corresponding to all content IDs (step S44). Referring to FIG. 5, the counter value of No. 05 is incremented to “10” by the counter 173, and this is TOP 1. Therefore, the processing by the main controller 17 advances to Yes in step S44.

If it is determined that the requested content data is preferential data (Yes in step S44), the first distribution controller 175 determines whether the requested content data is already stored in the second storage area 163 (step S45). If it is determined that the requested content data is not preferential data (No in step S44), the second distribution controller 176 outputs a read request to the RAID controller 15, and a buffer instruction to the output unit 16 (step S46). In accordance with the read request supplied from the main controller 17, the RAID controller 15 forms content data based on divided data and redundancy data read from the SSDs 14-1 to 14-n, and outputs the formed content data to the output unit 16. In accordance with the buffer instruction given by the main controller 17, the first storage area 162 of the output unit 16 holds the content data supplied from the RAID controller 15 in the ring buffer, and outputs the held content data to the MAC 161.

If it is determined in step S45 that the requested content data is already stored in the second storage area 163 (Yes in step S45), the first distribution controller 175 refers to management information recorded in the memory 171, and determines whether the cached content data is a part of the content data recorded in the SSDs 14-1 to 14-n (step S47). If the requested content data is not stored (No in step S45), the data size determination unit 177 determines whether the volume of the requested content data is smaller than an area allocated to cache one content data in the second storage area 163 (step S48).

If it is determined in step S47 that the cached content data is a part of the content data recorded in the SSDs 14-1 to 14-n (Yes in step S47), the first distribution controller 175 outputs a read request to which management information is added to the RAID controller 15, and an output instruction to the output unit 16. Then, the first distribution controller 175 distributes the content data from the second storage area 163, and outputs a buffer instruction to the output unit 16 (step S49). In accordance with the read request which is supplied from the main controller 17 and to which the management information is added, the RAID controller 15 reads content data within a range designated by the management information from the SSDs 14-1 to 14-n, and outputs the read content data to the output unit 16. In accordance with the output instruction given by the main controller 17, the second storage area 163 of the output unit 16 outputs the cached content data to the MAC 161. In accordance with the buffer instruction given by the main controller 17, the first storage area 162 of the output unit 16 holds the content data supplied from the RAID controller 15 in the ring buffer, and outputs the held content data to the MAC 161.

If it is determined in step S47 that the cached content data is the whole of the content data recorded in the SSDs 14-1 to 14-n (No in step S47), the first distribution controller 175 outputs an output instruction to the output unit 16 (step S410). In accordance with this output instruction given by the main controller 17, the second storage area 163 of the output unit 16 outputs the cached content data to the MAC 161.

If it is determined in step S48 that the volume of the requested content data is smaller than the allocated area (Yes in step S48), the data size determination unit 177 notifies the first distribution controller 175 of this information. In accordance with this notification, the first distribution controller 175 outputs a read request to the RAID controller 15, a buffer instruction to the output unit 16, and a cache instruction to the output unit 16 (step S411). In accordance with the read request supplied from the main controller 17, the RAID controller 15 forms content data based on the divided data and redundancy data read from the SSDs 14-1 to 14-n, and outputs the formed content data to the output unit 16. In accordance with the cache instruction given by the main controller 17, the second storage area 163 of the output unit 16 caches the content data supplied from the RAID controller 15. In accordance with the buffer instruction given by the main controller 17, the first storage area 162 of the output unit 16 holds the content data supplied from the RAID controller 15 in the ring buffer, and outputs the held content data to the MAC 161.

If the volume of the requested content data is larger than the allocated area (No in step S48), the data size determination unit 177 notifies the first distribution controller 175 of this information. In accordance with this notification, the first distribution controller 175 outputs a read request to the RAID controller 15, a buffer instruction to the output unit 16, and a cache instruction to the output unit 16 (step S412). In this step, the first distribution controller 175 records management information with which the range stored in the allocated area can be grasped in the memory 171. In accordance with the read request supplied from the main controller 17, the RAID controller 15 forms content data based on the divided data and redundancy data read from the SSDs 14-1 to 14-n, and outputs the formed content data to the output unit 16. In accordance with the cache instruction given by the main controller 17, the second storage area 163 of the output unit 16 caches a part of the content data supplied from the RAID controller 15 in the allocated area. In accordance with the buffer instruction given by the main controller 17, the first storage area 162 of the output unit 16 holds the content data supplied from the RAID controller 15 in the ring buffer, and outputs the held content data to the MAC 161.

In the first embodiment as described above, the main controller 17 gives ordinal numbers to content data in descending order of request count, based on the number of distribution requests. The main controller 17 regards high-order content data as preferential data, and causes the second storage area 163 to cache the content data as preferential data. When a distribution request for this content data as preferential data is supplied, the main controller 17 reads the cached content data, and distributes the data to the request source. Accordingly, content data having a high request frequency is read from the second storage area 163 where the data is cached, and distributed to the request source. That is, content data for which a distribution request is frequently issued need not be read from the SSDs 14-1 to 14-n whenever a distribution request is received. That is, it is possible to decrease the frequency at which a read instruction is given to the SSDs 14-1 to 14-n.

In the video distribution server according to the first embodiment, therefore, it is possible to decrease the number of times of a read process for the SSDs. Accordingly, the occurrence of a delay in the read process can be suppressed even in an environment in which a write process can be requested.

Also, in the first embodiment, if the volume of the requested content data is larger than the capacity of the allocated area in the second storage area 163, only partial content data cacheable in the allocated area is cached.

When a distribution request for this content data is issued, the part of the content data is read from the second storage area 163, and the rest is read from the SSDs 14-1 to 14-n. As a consequence, the data distribution server 10 can normally operate even when the volume of content data to be recorded in the SSDs 14-1 to 14-n is large.

### Second Embodiment

In the above first embodiment, content data as preferential data is wholly stored in the second storage area 163, or only a part of the content data, which can be stored in the second storage area 163, is stored in it. Accordingly, the second storage area 163 is required to have a large capacity to some extent. Also, when only a part of content data is stored in the second storage area 163, the rest of the content data is read from the SSDs. In this case, a delay may occur in this read from the SSDs. Therefore, the second embodiment is so configured as to further decrease the capacity of a second storage area 163, and further suppress the influence of a delay when reading data from SSDs.

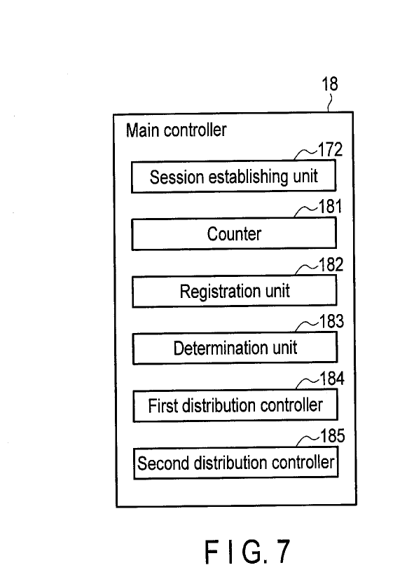

FIG. 7 is a block diagram showing the functional arrangement of a main controller 18 of a data distribution server 20 according to the second embodiment. In FIG. 7, the same reference numerals as in FIG. 3 denote the same parts.

When compared to the video distribution server shown in FIG. 2, the second embodiment includes a first storage area 164 instead of the first storage area 162. The first storage area 164 corresponding to the first storage area 162 shown in FIG. 2 is formed by, e.g., an SDRAM. In accordance with a buffer instruction given by a main controller 17, the first storage area 164 holds content data or partial content data supplied from a RAID controller 15 in a ring buffer. The first storage area 164 outputs the held content data or partial content data in accordance with processing of a MAC 161. In this embodiment, the partial content data is data of a preset time of the content data. Also, in accordance with a second output instruction given by the main controller 17, the first storage area 164 outputs the held partial content data to the MAC 161.

The main controller 18 shown in FIG. 7 includes, e.g., a CPU, and achieves functions shown in FIG. 7 by driving the CPU by using programs and data recorded in a memory 171. That is, the main controller 18 includes a session establishing unit 172, counter 181, registration unit 182, determination unit 183, first distribution controller 184, and second distribution controller 185.

When a distribution request is supplied from a request accepting unit 11, the counter 181 confirms the content ID of content data as a target of the distribution request. The counter 181 increments a counter value corresponding to the requested content ID. The counter 181 causes the memory 171 to store the counter value corresponding to the content ID. The counter 181 erases the counter value stored in the memory 171 whenever a preset time elapses.

The determination unit 183 determines whether the content ID of the requested content data is the same as a registered ID (to be described later) stored in the memory 171 by the registration unit 182 in the present time period. If the two IDs are the same, the determination unit 183 notifies the registration unit 182 of the content ID and counter value of the requested content data.

If the content ID of the requested content data is not the same as the registered ID stored in the memory 171 by the registration unit 182 in the present time period, the determination unit 183 compares counter values corresponding to all content IDs with registered counter values stored in the memory 171 by the registration unit 182, thereby determining whether the requested content data is preferential data. In the second embodiment, the preferential data are content data having ordinal numbers preset in descending order from the highest counter value and highest registered counter value, i.e., content data having counter values and registered counter values from the highest values to the Nth counter values.

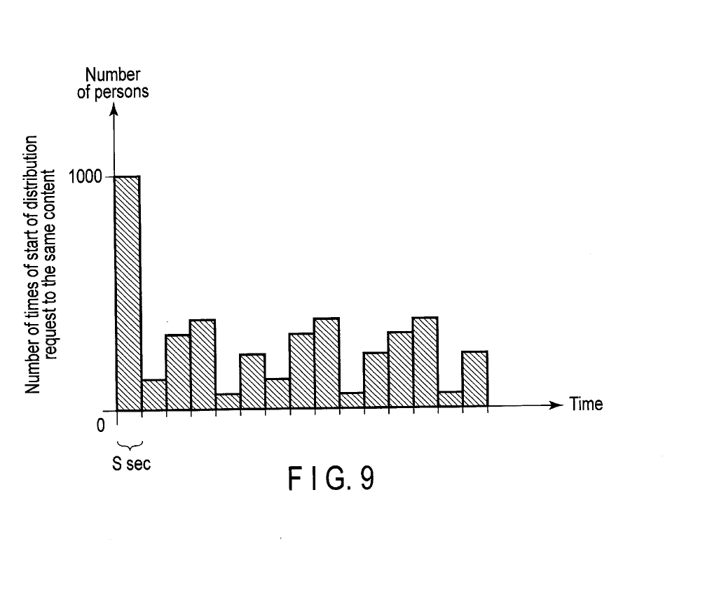

The registration unit 182 causes the memory 171 to store the content ID of the content data found to be preferential data by the determination unit 183, and the counter value when the content data is found to be preferential data, as a registered ID and registered counter value, respectively. Also, the registration unit 182 causes the memory 171 to store the time at which the registered ID and registered counter value are stored in the memory 171 as a registration time. This registration time indicates one of s-sec time periods in each of which distribution request counting is performed in FIG. 9 (to be described later).

Also, when the registration unit 182 is notified of the content ID and counter value by the determination unit 183, the registration unit 182 updates the registered counter value of the same registered ID as the notified content ID, based on the notified counter value. That is, this processing increments the registered counter value of the content data cached in the second storage area 163.

If the number of registered IDs recorded in the memory 171 is larger than the preset N by 1, the registration unit 182 deletes, from the memory 171, a minimum one of the registered counter values recorded in the memory 171, and a registered ID corresponding to the minimum registered counter value. That is, this processing excludes content data from preferential data even when the content data is being distributed.

Furthermore, when the registration unit 182 is notified by the first distribution controller 184 that the read of the content data recorded in the SSDs 14-1 to 14-n is completed to the end, the registration unit 182 erases the registered ID and registered counter value notified by the first distribution controller 184, from the registered IDs and registered counter values recorded in the memory 171. That is, this processing excludes content data cached in the second storage area 163 from preferential data when the content data reaches the end.

If the determination unit 183 determines that the content ID of the requested content data is the same as the registered ID registered in the present time period, the first distribution controller 184 outputs a second output instruction to an output unit 16 so as to output the partial content data buffered in the first storage area 164. That is, if a plurality of distribution requests are issued for the same content data in the same time period, this processing distributes buffered partial content data in response to the requests.

If the determination unit 183 determines that the requested content data is not the same as the registered ID registered in the present time period, and that the requested content data is preferential data, the first distribution controller 184 outputs a read request designating a read range to the RAID controller 15 so as to output partial content data at the point of time at which the distribution request is received. The first distribution controller 184 outputs a buffer instruction to the output unit 16 so as to hold the partial content data output from the RAID controller 15 in the ring buffer. The first distribution controller 184 outputs a cache instruction to the output unit 16 so as to cache the partial content data output from the RAID controller 15 in the second storage area 163. That is, in this processing, content data found to be preferential data for the first time in the same time period is buffered in the first storage area 164, and then distributed and cached in the second storage area 163.

Also, whenever a preset time elapses, the first distribution controller 184 refers to the registered IDs and registration times recorded in the memory 171, and determines whether there is content data newly added to preferential data. If there is content data newly added to preferential data, the first distribution controller 184 stops partial content data currently being output from the first storage area 164, and outputs a stop instruction and first output instruction to the output unit 16 so as to output partial content data from the second storage area 163. Consequently, partial content data cached in the second storage area 163 is distributed to a user to whom partial content data buffered in the first storage area 164 has been distributed. That is, for content data newly added to preferential data in a preceding time period, this processing switches partial content data distribution sources from partial content data buffered in the first storage area 164 to partial content data cached in the second storage area 163.

Furthermore, whenever a preset time elapses, the first distribution controller 184 refers to the registered IDs and registration times stored in the memory 171, and determines whether there is content data excluded from preferential data. If there is content data excluded from preferential data, the first distribution controller 184 outputs a read request to the RAID controller 15 so as to output this content data. The first distribution controller 184 outputs a buffer instruction to the output unit 16 so as to buffer the content data output from the RAID controller 15 in the first storage area 164. Consequently, the content data buffered in the second storage area 164 is distributed to a user to whom the partial content data cached in the second storage area 163 has been distributed. That is, for content data found to be non-preferential data in a preceding time period, this processing switches partial content data distribution sources from the partial content data cached in the second storage area 163 to the partial content data buffered in the first storage area 164.

In addition, whenever a preset time elapses, the first distribution controller 184 outputs a delete instruction to the second storage area 163 so as to delete the oldest partial content data from a plurality of partial content data cached in the second storage area 163. In order to cache a preset number of partial content data in the second storage area 163, the first distribution controller 184 causes, whenever a preset time elapses, the RAID controller 15 to output partial content data for the next time period of content data corresponding to the registered ID recorded in the memory 171. Whenever a preset time elapses, therefore, the first distribution controller 184 outputs a read request designating a read range to the RAID controller 15. The first distribution controller 184 outputs a cache instruction to the output unit 16 so as to cache the partial content data output from the RAID controller 15 in the second storage area 163. That is, these processes replace partial content data to be cached with partial content data to be distributed next, with the elapse of time.

Also, the first distribution controller 184 determines whether the read of the content data recorded in the SSDs 14-1 to 14-n is completed to the end by the partial content data cached in the second storage area 163. If the read of the content data recorded in the SSDs 14-1 to 14-n is completed to the end, the first distribution controller 184 notifies the registration unit 182 of the completion of the read. Based on this notification, the registration unit 182 erases the notified registered ID and registered counter value from the registered IDs and registered counter values recorded in the memory 171. That is, when content data cached in the second storage area 163 has reached the end, this processing excludes the content data from preferential data.

If the determination unit 183 determines that the requested content data is not preferential data, the second distribution controller 185 outputs a read request to the RAID controller 15 so as to output content data recorded in the SSDs 14-1 to 14-n. The second distribution controller 185 outputs a buffer instruction to the output unit 16 so as to hold the content data output from the RAID controller 15 in the ring buffer.

Next, the operation of the data distribution server 20 configured as described above will be explained in detail.

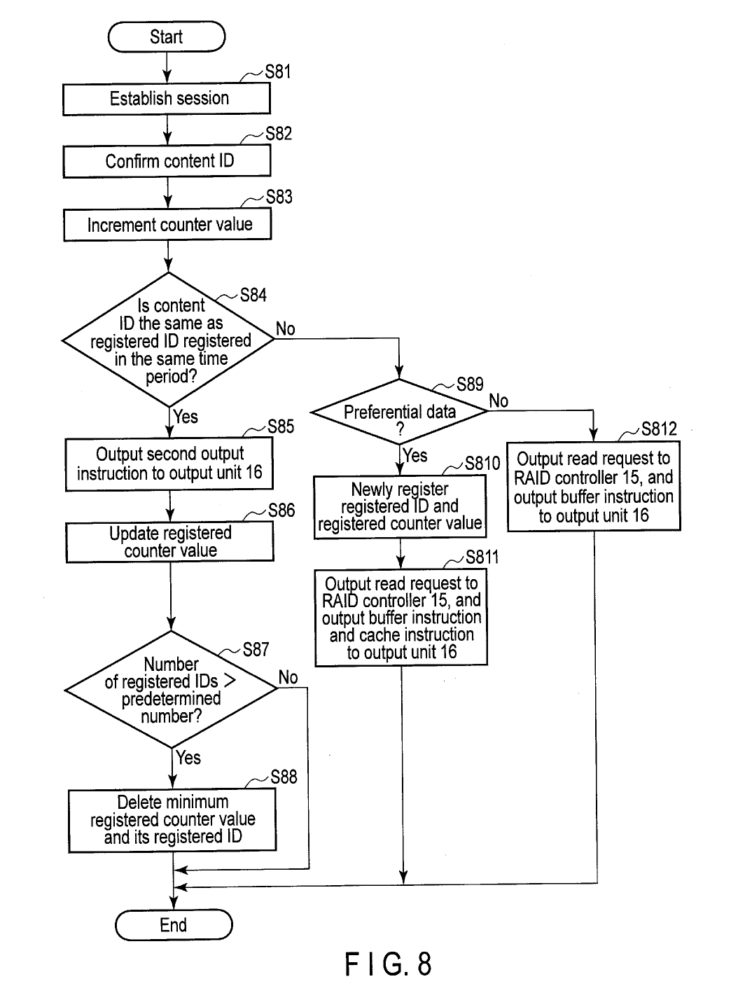

FIG. 8 is a flowchart showing the operation of the main controller 18 in a case in which the data distribution server 20 according to this embodiment receives a distribution request, and the leading data of the requested content data is output. FIG. 9 shows an example of a change in number of distribution requests with time with respect to content data having content ID: No. 05 when a preset time is s sec. Referring to FIG. 8, the operation will be explained by taking, as an example, a case in which the present time is 0 to s sec, the counter value of content ID: No. 05 for 0 to s sec is “999”, and a 1,000th distribution request for this content data is received. Also, referring to FIG. 8, the operation will be explained by taking, as an example, a case in which it is determined that top three content data from one having the highest counter value and highest registered counter value are preferential data, and content ID: No. 05 is TOP 1 content data. In this case, the registered ID “No. 05” and registered counter value “999” are stored in the memory 171.

First, when the 1,000th distribution request for content ID: No. 5 is supplied from the request accepting unit 11, the main controller 18 causes the session establishing unit 172 to output a session establishment request to the output unit 16 (step S81). In accordance with the session establishment request supplied from the main controller 18, the MAC 161 of the output unit 16 establishes a session with a communication terminal 30 having transmitted the distribution request.

The counter 181 confirms that the content data as a target of the distribution request is No. 05 (step S82). The counter 181 increments a counter value corresponding to content ID: No. 05 to “1000” (step S83).

To determine whether content ID: No. 05 is content data found to be preferential data within 0 to s sec, the determination unit 183 refers to the registered IDs and registration times recorded in the memory 171, and determines whether content ID: No. 05 is the same as the registered ID stored in the memory 171 by the registration unit 182 in a time period of 0 to s sec (step S84). This processing avoids caching the same partial content data in the second storage area 163 in the same time period. Since content ID: No. 05 is the content data found to be preferential data within 0 to s sec, it is determined that content ID: No. 05 is the same as the registered ID (Yes in step S84), and the first distribution controller 184 outputs a second output instruction to the output unit 16 so as to output the first partial content data of No. 05, which is buffered in the first storage area 164 (step S85). Upon receiving the second output instruction given by the main controller 18, the output unit 16 outputs the first partial content data of No. 05, which is buffered in the first storage area 164. Also, since content ID: No. 05 is the content data found to be preferential data within 0 to s sec, the determination unit 183 notifies the registration unit 182 of registered ID: No. 05 and the counter value of No. 05. Based on this notification from the determination unit 183, the registration unit 182 updates the registered counter value corresponding to registered ID: No. 0.5 by the counter value of No. 05 (step S86).

Subsequently, the registration unit 182 determines whether the number of registered IDs recorded in the memory 171 is larger than 3 by 1 (step S87). If the number of registered IDs is 4 (Yes in step S87), a minimum one of the registered counter values recorded in the memory 171 and a registered ID corresponding to the minimum registered counter value are deleted from the memory 171 (step S88). If the number of registered IDs is 3 or less (No in step S87), the main controller 18 terminates the process. Since the registered counter value is updated in step S86, content data having top four counter values and top four registered counter values may be cached in the second storage area 163. By the processes in steps S87 and S88, a state in which content data having top three counter values and top three registered counter values are cached is secured in the second storage area 163.

If it is determined in step S84 that the content ID of the requested content data is not the same as the registered ID stored in the memory 171 by the registration unit 182 in a time period of 0 to s sec (No in step S84), the determination unit 183 compares counter values corresponding to all content IDs with the registered counter values stored in the memory 171, and determines whether the requested content data is preferential data (step S89).

If it is determined that the requested content data is preferential data, i.e., if it is determined that the requested content data is the first preferential data within 0 to s sec (Yes in step S89), the registration unit 182 registers the content ID and counter value of the requested content data as a registered ID and registered counter value in the memory 171 (step S810).

Subsequently, the first distribution controller 184 outputs a read request designating a read range to the RAID controller 15, a buffer instruction to the output unit 16, and a cache instruction to the output unit 16 (step S811). In accordance with the read request supplied from the main controller 18, the RAID controller 15 forms partial content data at the present point of time based on divided data and redundancy data read from the SSDs 14-1 to 14-n, and outputs the formed partial content data to the output unit 16. In accordance with the cache instruction given by the main controller 18, the second storage area 163 of the output unit 16 caches the partial content data supplied from the RAID controller 15. In accordance with the buffer instruction given by the main controller 18, the first storage area 164 of the output unit 16 holds the partial content data supplied from the RAID controller 15 in the ring buffer, and outputs the held partial content data to the MAC 161.

If it is determined in step S89 that the requested content data is not preferential data (No in step S89), the second distribution controller 185 outputs a read request to the RAID controller 15, and a buffer instruction to the output unit 16 (step S812). In accordance with the read request supplied from the main controller 18, the RAID controller 15 forms content data based on the divided data and redundancy data read from the SSDs 14-1 to 14-n, and outputs the formed content data to the output unit 16. In accordance with the buffer instruction given by the main controller 17, the first storage area 164 of the output unit 16 holds the content data supplied from the RAID controller 15 in the ring buffer, and outputs the held content data to the MAC 161.

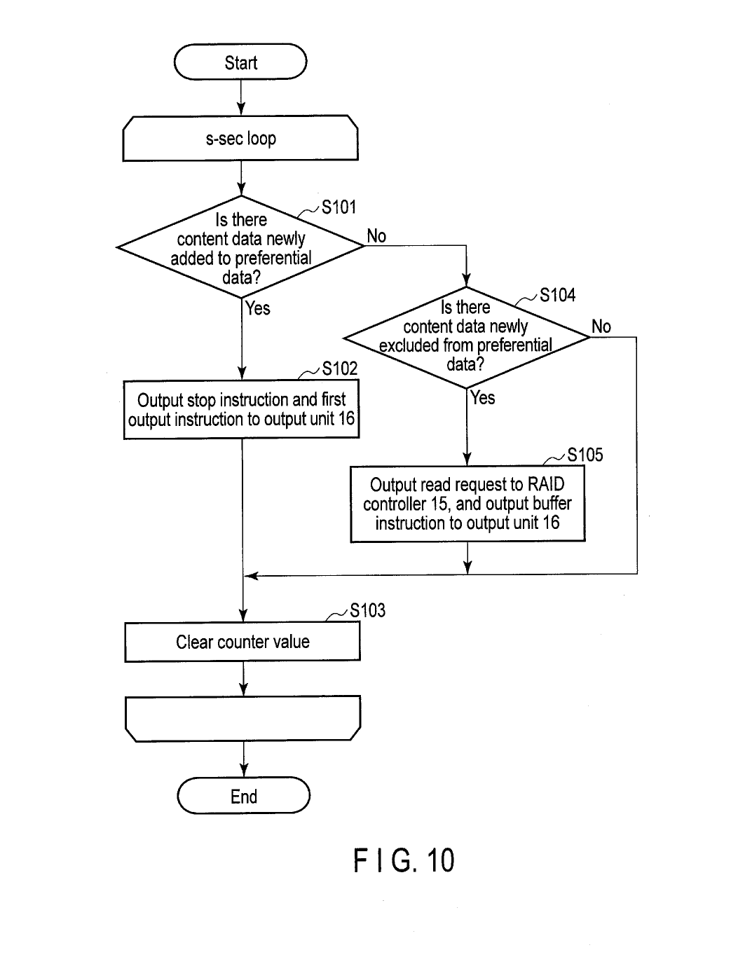

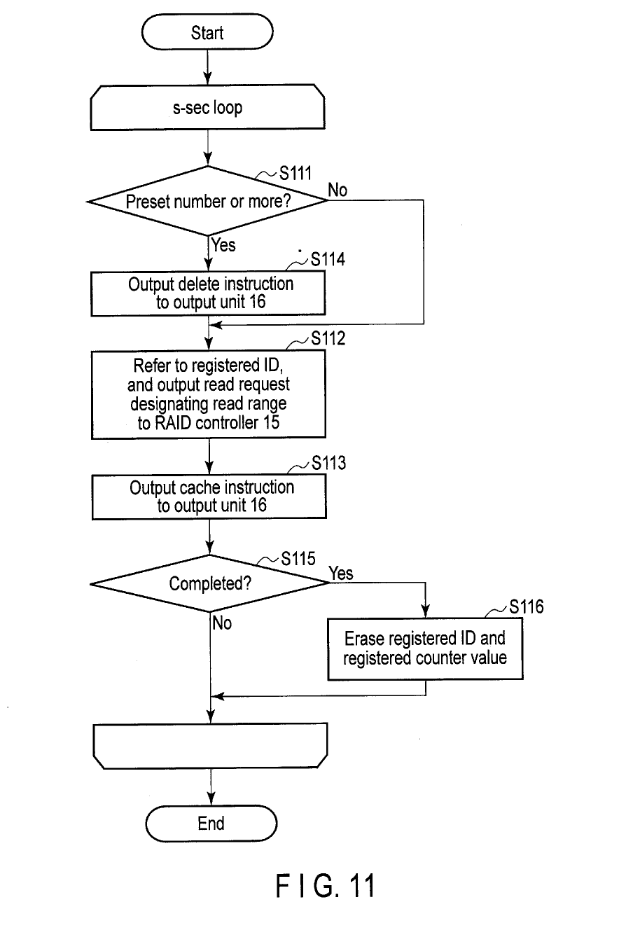

The foregoing is the flowchart showing the operation of the main controller 18 in a case in which the data distribution server 20 receives a distribution request, and the leading data of the requested content data is output. Content data from one next to the leading data are sequentially cached in the second storage area 163, as long as the content data is preferential data, and content data from the leading content data are output from the second storage area 163. The distribution of the content data from the one next to the leading data will be explained with reference to FIG. 10. The caching of the content data from the one next to the leading data to the second storage area 163 will be explained with reference to FIG. 11.

FIG. 10 is a flowchart showing an operation by which the main controller 18 according to this embodiment outputs the content data from one next to the leading data, and, if the ordinal numbers of preferential data are switched, switches storage areas which output partial content data in accordance with the switching of the ordinal numbers.

After the process shown in FIG. 8, i.e., after the process of outputting the leading data of the content data, the first distribution controller 184 repeats a process shown in FIG. 10 for every s sec. First, the first distribution controller 184 refers to the registered IDs and registration times recorded in the memory 171, and determines whether there is content data newly added to preferential data by the process shown in FIG. 8 which is performed in previous s sec (step S101). If there is content data newly added to preferential data by the process shown in FIG. 8 which is performed in previous s sec (Yes in step S101), the first distribution controller 184 outputs, to the output unit 16, a stop instruction and a first output instruction for outputting partial content data from the second storage area 163 (step S102). In accordance with the stop instruction given by the main controller 18, the first storage area 164 of the output unit 16 stops outputting the buffered partial content data. In accordance with the first output instruction given by the main controller 18, the second storage area 163 of the output unit 16 outputs the cached partial content data. By the processes in steps S101 and S102, for content data newly added to preferential data in a preceding time period, partial content data cached in the second storage area 163 is distributed to the request source.

The counter 181 clears all counter values (step S103), and terminates the process for every s sec.

If there is no content data newly added to preferential data by the process shown in FIG. 8 which is performed in previous s sec (No in step S101), the first distribution controller 184 refers to registered IDs deleted from the memory 171, and determines whether there is content data excluded from preferential data by the process shown in FIG. 8 which is performed in previous s sec (step S104). If there is content data excluded from preferential data by the process shown in FIG. 8 which is performed in previous s sec (Yes in step S104), the first distribution controller 184 outputs a read request to the RAID controller 15 and a buffer instruction to the output unit 16 (step S105), and advances the process to step S103. In accordance with the read request supplied from the main controller 18, the RAID controller 15 reads content data from the SSDs 14-1 to 14-n, and outputs the read content data to the output unit 16. In accordance with the buffer instruction given by the main controller 18, the first storage area 164 of the output unit 16 holds the partial content data supplied from the RAID controller 15 in the ring buffer, and outputs the held partial content data to the MAC 161. If there is no content data excluded from preferential data by the process shown in FIG. 8 which is performed in previous s sec (No in step S104), the first distribution controller 184 advances the process to step S103. By the processes in steps S104 and S105, for content data found to be non-preferential data in the preceding time period, partial content data buffered in the first storage area 164 is distributed to the request source.

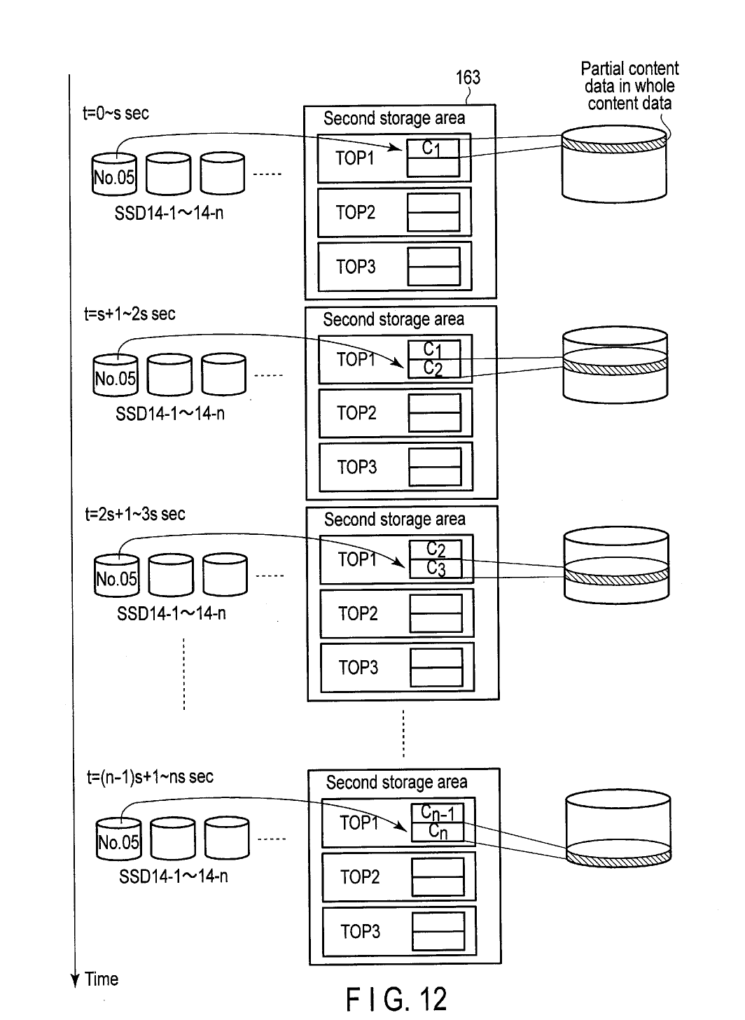

FIG. 11 is a flowchart showing an operation by which the main controller 18 according to this embodiment caches partial content data from one next to the leading partial content data in the second storage area 163. FIG. 12 is a schematic view showing an example of partial content data having content ID: No. 05 to be cached in the second storage area 163. Note that in FIG. 12, content ID: No. 05 is registered as TOP 1 preferential data because 1,000 distribution requests have been issued for content ID: No. 05 by the process shown in FIG. 8 for t=0 to s sec, and content ID: No. 05 is recorded as a registered ID in the memory 171 until ns sec after the registration. Note also that first partial content data C1 is cached in the second storage area 163 by the process shown in FIG. 8 for t=0 to s sec.

After the process shown in FIG. 8, i.e., after the process of outputting the leading partial content data, the first distribution controller 184 repeats the process shown in FIG. 11 for every s sec. First, the first distribution controller 184 determines whether M, as a preset number, partial content data of the content data having registered ID: No. 05 are cached in the second storage area 163, i.e., determines whether an area of the second storage area 163, which is allocated to cache TOP 1 partial content data, has a free space (step S111). Note that in the explanation of FIG. 12, the preset number M is 2.

When t=s+1 in FIG. 12, only the partial content data C1 is cached in the second storage area 163, i.e., two, as a preset number, partial content data are not cached in the second storage area 163 (No in step S111), so the first distribution controller 184 refers to registered IDs recorded in the memory 171, outputs a read request designating a read range to the RAID controller 15 so as to read partial content data C2 having registered ID: No. 05 (step S112), and outputs a cache instruction to the output unit 16 (step S113). Upon receiving the read request designating a read range, the RAID controller 15 outputs the partial content data C2 to the output unit 16. In accordance with the cache instruction, the output unit 16 caches the partial content data C2 output from the RAID controller 15 in the second storage area 163.

When t=2s+1 in FIG. 12, the partial content data C1 and C2 are cached in the second storage area 163, i.e., two, as a preset number, partial content data are cached in the second storage area 163 (Yes in step S111), so the first distribution controller 184 outputs a delete instruction to the output unit 16 (step S114), and advances the process to step S112 so as to read partial content data C3. Consequently, the partial content data C3 is newly cached in the second storage area 163. In accordance with the delete instruction, the output unit 16 deletes the partial content data C1, as the oldest partial content data, from the plurality of partial content data cached in the second storage area 163.

Also, when t=(n−1)s+1 in FIG. 12, partial content data Cn−2 and Cn−1 are cached in the second storage area 163, i.e., two, as a preset number, partial content data are cached in the second storage area 163 (Yes in step S111), so the first distribution controller 184 outputs a delete instruction to the output unit 16 (step S114), and advances the process to step S112 so as to read partial content data Cn. Consequently, the partial content data Cn is newly cached in the second storage area 163. In accordance with the delete instruction, the output unit 16 deletes the partial content data Cn−2 as the oldest one of the plurality of partial content data cached in the second storage area 163.

When the partial content data is cached in the second storage area, the first distribution controller 184 determines whether the read of the content data recorded in the SSDs 14-1 to 14-n is completed to the end (step S115). If the read of the content data recorded in the SSDs 14-1 to 14-n is not completed to the end, i.e., if t=s+1 and 2s+1 in FIG. 12 (No in step S115), the first distribution controller 184 terminates the process for every s sec. If the read of the content data recorded in the SSDs 14-1 to 14-n is completed to the end, i.e., if t=(n−1)s+1 sec in FIG. 12 (Yes in step S115), the first distribution controller 184 causes the registration unit 182 to erase registered ID: No. 05 and registered counter value: “1000” corresponding to registered ID: No. 05 (step S116), from the registered IDs and registered counter values recorded in the memory 171. After the processes in steps S115 and S116, content ID: No. 05 is no longer preferential data.

In the second embodiment as described above, the main controller 18 gives ordinal numbers to content data in descending order of request count, based on the number of distribution requests in a predetermined period. The main controller 18 adds content data given ordinal numbers preset from the highest one to preferential data. The main controller 18 causes the second storage area 163 to sequentially cache partial content data in a predetermined period of the content data as preferential data. Then, the main controller 18 distributes the cached partial content data to the request source. Accordingly, content data having a high request frequency is read from the second storage area 163 where the data is cached, and distributed to the request source. That is, content data for which a distribution request is frequently issued need not be read from the SSDs 14-1 to 14-n whenever a distribution request is received. That is, it is possible to suppress the frequency at which a read instruction is given to the SSDs 14-1 to 14-n.

Also, not all content data but partial content data in a predetermined period are sequentially cached in the second storage area 163. Therefore, it is possible to suppress the frequency of a read process for the SSDs 14-1 to 14-n without allocating a large capacity to the second storage area 163.

Accordingly, the video distribution server according to the second embodiment can suppress the number of times of the read process for the SSDs, and hence can suppress the occurrence of a delay in the read process even in an environment in which a write process can be requested. Furthermore, in the video distribution server according to the second embodiment, even when the volume of content data for which many distribution requests are issued, i.e., the volume of preferential data is larger than the second storage area 163, content data from one next to the leading data of the content data are cached in the second storage area 163 and then output. This makes it possible to further suppress the read delay of preferential data.

Note that in the second embodiment, if content data which is the same as content data found to be preferential data in a preceding period is newly found to be preferential data in the next period, partial content data at this point of time is newly cached in the second storage area 163. However, the present invention is not limited to this. For example, if the same content data is found to be preferential data in the next period, the first distribution controller 184 may also leave partial content data cached at the preceding point of time behind without erasing it.

If distribution of the same content data is requested in the next period, the first distribution controller 184 distributes the partial content data which is not erased but left behind in the second storage area 163 to the request source. This makes it possible to avoid recording a plurality of registered IDs in the memory 171 for the same content data, and avoid separately caching the same partial content data in the second storage area 163.

Also, in the second embodiment, the first distribution controller 184 switches storage areas for outputting partial content data when a preset time elapses. However, the present invention is not limited to this. For example, the first distribution controller 184 may also output partial content data cached in the second storage area 163 as soon as the read of partial content data buffered in the first storage area 164 is completed. Furthermore, the first distribution controller 184 may buffer content data in the first storage area 164 as soon as the read of partial content data cached in the second storage area 163 is completed.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A video distribution server comprising:
a Solid State Drive (SSD) in which a plurality of content data are written;
a counter configured to, when distribution of one of the plurality of content data written in the SSD is requested, increment a counter value of the content data for which distribution is requested;
a determination unit configured to determine whether the requested content data belongs to preferential data having ordinal numbers preset in descending order of counter value, by comparing counter values of the individual content data;
an output unit including a first storage area which buffers content data read from the SSD, and a second storage area which caches content data read from the SSD, and configured to distribute one of content data buffered in the first storage area and content data cached in the second storage area;
a first distribution controller configured to:
receive a first distribution request;
when first target content data as a target of the first distribution request belongs to the preferential data, read the first target content data from the SSD;
buffer the read first target content data in the first storage area;
cache the read first target content data in the second storage area; and
distribute the buffered first target content data to a request source of the first distribution request; and
a second distribution controller configured to:
receive a second distribution request;
when second target content data as a target of the second distribution request does not belong to the preferential data, read the second target content data from the SSD in accordance with the second distribution request;
buffer the read second target content data in the first storage area; and
distribute the second target content data to a request source of the second distribution request,
wherein when receiving a third distribution request for the first target content data after the first target content data is cached in the second storage area, the first distribution controller distributes the cached first target content data in the second storage area to a request source of the third distribution request.

2. The video distribution server according to claim 1, further comprising a volume determination unit configured to determine whether a volume of the first target content data is larger than a capacity of the second storage area,
wherein when the volume of the first target content data is larger than the capacity of the second storage area, the first distribution controller causes the second storage area to cache a part of the first target content data read from the SSD in accordance with the first distribution request, and
in accordance with the third distribution request, the first distribution controller reads a part of the first target content data from the second storage area, distributes the part of the first target content data to the request source of the third distribution request, reads the rest of the first target content data from the SSD, and distributes the rest of the first target content data to the request source of the third distribution request.

3. A video distribution server comprising:
a Solid State Drive (SSD) in which a plurality of content data are written;
a counter configured to, when distribution of one of the plurality of content data written in the SSD is requested, increment a counter value of the content data for which distribution is requested, and erase the counter value whenever a preset period elapses;
a determination unit configured to compare a counter value of each content data with a registered counter value registered before a present period, thereby determining whether the requested content data belongs to preferential data having ordinal numbers preset in descending order of counter value and registered counter value;
a registration unit configured to register an ID of content data found to belong to the preferential data, and a counter value when the content data is found to belong to the preferential data, as a registered ID and a registered counter value;
an output unit including a first storage area which buffers content data read from the SSD, and a second storage area which caches content data read from the SSD, and configured to distribute one of content data buffered in the first storage area and content data cached in the second storage area;
a first distribution controller configured to:
when first target content data as a target of a first distribution request received in the preset period belongs to the preferential data, sequentially read partial data equivalent to the preset period in the first target content data from the SSD;
cache the partial data in the second storage area; and
distribute the partial data cached in the second storage area to a request source of the first distribution request; and
a second distribution controller configured to:
when second target content data as a target of a second distribution request received in the preset period does not belong to the preferential data, read the second target content data from the SSD in accordance with the second distribution request;
buffer the read second target content data in the first storage area; and
distribute the second target content data to a request source of the second distribution request.

4. The video distribution server according to claim 3, wherein whenever the preset period elapses, the first distribution controller causes the second storage area to delete oldest partial data of the partial data cached in the second storage area.

5. The video distribution server according to claim 3, wherein when read to an end of content data specified by the registered ID is completed, the registration unit deletes a registered ID and registered counter value of the completed content data.

6. The video distribution server according to claim 3, wherein when receiving the first distribution request, the first distribution controller buffers the read partial data in the first storage area, distributes the partial data buffered in the first storage area to the request source of the first distribution request in the preset period, and distributes the partial data cached in the second storage area to the request source of the first distribution request from a period next to the preset period.

7. The video distribution server according to claim 3, wherein when receiving a third distribution request for the first target content data in a period different from the period in which the first distribution request is received, the first distribution controller distributes partial data cached in the second storage area to the request source of the first distribution request.

8. A distribution method to be used in a video distribution server including a Solid State Drive (SSD) in which a plurality of content data are written, the method comprising:
when distribution of one of the plurality of content data written in the SSD is requested, incrementing a counter value of the content data for which distribution is requested;
determining whether the requested content data belongs to preferential data having ordinal numbers preset in descending order of counter value, by comparing counter values of the individual content data;
when first target content data as a target of a received first distribution request belongs to the preferential data:
reading the first target content data from the SSD;
buffering the read first target content data in a first storage area;
caching the read first target content data in a second storage area; and
distributing the buffered first target content data to a request source of the first distribution request;
when receiving a third distribution request for the first target content data after the first target content data is cached in the second storage area, distributing the first target content data cached in the second storage area to a request source of the third distribution request; and
when second target content data as a target of a received second distribution request does not belong to the preferential data:
reading the second target content data from the SSD in accordance with the second distribution request;
buffering the read second target content data in the first storage area; and
distributing the second target content data to a request source of the second distribution request.

9. The distribution method according to claim 8, comprising:
determining whether a volume of the first target content data is larger than a capacity of the second storage area;
when the volume of the first target content data is larger than the capacity of the second storage area, caching a part of the first target content data read from the SSD in accordance with the first distribution request in the second storage area; and
in accordance with the third distribution request, reading a part of the first target content data from the second storage area, distributing the part of the first target content data to the request source of the third distribution request, reading the rest of the first target content data from the SSD, and distributing the rest of the first target content data to the request source of the third distribution request.

10. A distribution method to be used in a video distribution server including a Solid State Drive (SSD) in which a plurality of content data are written, the method comprising:
when distribution of one of the plurality of content data written in the SSD is requested, incrementing a counter value of the content data for which distribution is requested;
erasing the counter value whenever a preset period elapses;
comparing a counter value of each content data with a registered counter value registered before a present period, thereby determining whether the requested content data belongs to preferential data having ordinal numbers preset in descending order of counter value and registered counter value;
registering an ID of content data found to belong to the preferential data, and a counter value when the content data is found to belong to the preferential data, as a registered ID and a registered counter value;
when first target content data as a target of a first distribution request received in the preset period belongs to the preferential data:
sequentially reading partial data equivalent to the preset period in the first target content data from the SSD;
caching the partial data in a second storage area; and
distributing the partial data cached in the second storage area to a request source of the first distribution request; and
when second target content data as a target of a second distribution request received in the preset period does not belong to the preferential data:
reading the second target content data from the SSD in accordance with the second distribution request;
buffering the read second target content data in a first storage area; and
distributing the second target content data to a request source of the second distribution request.

11. The distribution method according to claim 10, wherein whenever the preset period elapses, oldest partial data of the partial data cached in the second storage area is deleted from the second storage area.

12. The distribution method according to claim 10, wherein when read to an end of content data specified by the registered ID is completed, a registered ID and registered counter value of the completed content data are deleted.

13. The distribution method according to claim 10, wherein when the first distribution request is received, the read partial data is buffered in the first storage area, the partial data buffered in the first storage area is distributed to the request source of the first distribution request in the preset period, and the partial data cached in the second storage area is distributed to the request source of the first distribution request from a period next to the preset period.

14. The distribution method according to claim 10, wherein when a third distribution request for the first target content data is received in a period different from the period in which the first distribution request is received, partial data cached in the second storage area is distributed to the request source of the first distribution request.
